(19) United States
(12) Patent Application Publication
(10) Pub. No.: US 2007/0063130 A1
(43) Pub. Date: Mar. 22, 2007

(54) Optical pointing apparatus and personal portable device having the optical pointing apparatus

(76) Inventors: Keon Joon Ahn, Kyunggi-do (KR); Chul Park, Kyunggi-do (KR); Jae Dong Kim, Kyunggi-do (KR); Jae Hun Bae, Kyunggi-do (KR)

Correspondence Address: Hammer & Hanf, Suite G, 3125 Springbank Lane, Charlotte, NC, 28226, US

(21) Appl. No.: 10/579,702

(22) PCT Filed: Jun. 10, 2005
(86) PCT No.: PCT/KR05/01747

§ 371 Date: May 19, 2006

(30) Foreign Application Priority Data
Jul. 29, 2004 (KR) 10-2004-0059645
Nov. 5, 2004 (KR) 10-2004-0089456
Jan. 21, 2005 (KR) 10-2004-0005935

(51) Int. Cl. G06M 7/00

(52) U.S. Cl. 250/221

(57) ABSTRACT

There are provided an optical pointing device and a personal portable device employing the same, the optical pointing device in which a horizontal optical path is formed, thereby minimizing the thickness of an optical system and providing a sufficient depth of a focus. The optical pointing device includes a cover glass directly contacting an object, a light source unit emitting light to the cover glass, and a light receiving unit reflecting the light reflected by the object in a predetermined direction via the cover glass and condensing the light in the predetermined direction, and picking up an image of the light. According to the present invention, pointing is possible by using the surface of a finger and a horizontal optical path is formed such that the thickness of an optical system is minimized, and a sufficient depth of a focus is provided, thereby keeping a beautiful exterior of an ultra slim personal portable device and performing convenient pointing.

### TECHNICAL FIELD

The present invention relates to a user interface device, and more particularly, relates to an optical pointing device capable of being installed in a slim personal portable device such as a mobile phone and a personal portable device employing the optical pointing device.

### BACKGROUND ART

Generally, a personal portable device such as a mobile phone and personal digital assistants (PDA) employs a user interface using a keypad. Particularly, a conventional personal portable device includes a keypad formed of a plurality of buttons for inputting numbers or letters such that a user pushes the button of the keypad in order to input telephone numbers or sentences.

Recently, since wireless Internet service such as wireless broadband (WIBRO) service is commonly used, a Windows operation system supporting a graphical user interface (GUI) is employed in a personal portable device. There is a Windows CE as an operating system (OS) for the personal portable device. Also, as development of technology, a personal portable device includes various additional services and the Windows operation system supporting the GUI is employed in order to conveniently use the various additional services

Since the operation system of the GUI is generally used in a personal portable device as described above, the development of a pointing device proper for a personal portable device is keenly needed.

Generally, there are a ball mouse, an optical mouse, a laser mouse, a touch pad, and a tablet as a pointing device for the GUI. The pointing device is applied to a computer, and it is theoretically possible that the pointing device is employed as a pointing device of a personal portable device.

However, since the prime purpose of a personal portable device is portability, it is inconvenient and inconsistent with reality to carry an additional pointing device apart from the portable device. Also, some pointing devices like trackball and joystick might be employed to the portable device, but the trackball and the joystick physically occupy a sizable space, so that they are rarely employed in a slim and small personal portable device.

Hereinafter, the theory of pointing of an optical mouse among the pointing device will be described in detail with reference to a drawing.

FIG. 1 is a cross-sectional view illustrating an optical system for explaining the theory of pointing of a general optical mouse.

An optical system 100 of the optical mouse includes a light source 102, a light source guide 104, a cover glass 106, a condensing lens 108, a shading unit 110, and an optical image sensor 112. The light source 102 is a high brightness light-emitting diode (LED). Light emitted from the light source 102 travels through the light source guide 104 and cover glass to be scanned on the ground G. The scanned light is reflected by the ground G to travel to the condensing lens 108 via the cover glass 106 again. The condensing lens 108 condenses the light reflected by the ground G and focuses the light on the light image sensor 112. The shading unit 110 for removing noise light is formed between the optical image sensor 112 and the condensing lens 108. The optical image sensor 112 picks up an image corresponding to the light condensed via the condensing lens 108. The pick up information is provided to an image processing unit (not shown) in order to detect the movement of the ground that is an object.

In the described conventional optical mouse, since the cover glass 106, the condensing lens 108, and the optical image sensor 112 are vertically arranged in the direction of the optical axis, the optical system should secure a predetermined thickness enough to have an available focal depth. Namely, it is very restricted to make the optical system slim because of securing the focal depth.

Hereinafter, the lowest limit of the focal depth in the conventional optical system will be described with reference to FIGS. 2 and 3. FIGS. 2 and 3 are schematic diagrams illustrating the relation between a focal length and a focal depth.

FIG. 2 is a schematic diagram illustrating an optical system with a short focal length. When light 200 is emitted to a condensing lens 202, a focus is formed on the surface of an optical image sensor 204. As the focal length is short, since the angle of the light inputted to the surface of the optical image sensor 204 is very large, if the focal length is deviated a little, the focal spot of the light 200 becomes very large. If the size of the focal spot is larger than the pixel size of the optical image sensor 204, since an image is not normally processed, the optical system with the short focal length is difficult to arrange and an error rate becomes high.

On the other hand, referring to FIG. 3 illustrating an optical system with a long focal length, when light 300 is emitted to a condensing lens 302, a focus is formed on the surface of an optical image sensor 304.

Since the distance from the condensing lens 302 to the top surface of the optical image sensor 304 is sufficiently long in the optical system of FIG. 3, though the surface of the optical image sensor is deviated a little, a small focal spot may be maintained. Accordingly, if there is some tolerance, the size of the focal spot is not larger than the pixel of the image sensor 304, thereby easily arranging and reducing an error rate.

As described above, in the conventional optical mouse, a cover glass, a condensing lens, and an image sensor are vertically arranged in the direction of the optical axis, and the thickness of an optical system is restricted due to the limit of the depth of the focus of the optical system.

According to a current level of technology, the minimum thickness of the optical system of the optical mouse is about 4-5 mm.

Therefore, if the shape of the described optical mouse is changed, the optical mouse cannot be employed to a personal portable device due to the limit of the thickness of the optical system.

Accordingly, it is much needed to develop an ultra slim pointing device that can be employed to a personal portable device pursuing an ultra slim size and beauty.

### DISCLOSURE OF INVENTION

Technical Goals

The present invention provides an optical pointing device and a personal portable device, the optical pointing device in which pointing using the movement of the finger is possible

The present invention also provides an optical pointing device and a personal portable device which has a horizontal optical path, thereby minimizing the thickness of an optical system and providing a sufficient depth of a focus.

The present invention also provides an optical pointing device and a personal portable device, which can minimize the loss of the light on an optical path.

The present invention also provides an optical pointing device and a personal portable device, in which though a horizontal optical path is formed, an optical image sensor is stably installed on a horizontal PCB.

Technical Solutions

To solve the problems, according to an aspect of the present invention, there is provided an optical pointing device including a cover glass directly contacting an object, a light source unit emitting light to the cover glass, and a light receiving unit guiding the light reflected by the object on the cover glass in a predetermined direction, condensing the guided light, and picking up an image of the condensed light.

The present invention provides an optical pointing device in which pointing is possible by using the surface of a finger, and more particularly, the thickness of an optical system is minimized to less than 2 mm and a sufficient depth of a focus is provided, such as about 15-30 mm.

Therefore, the present invention allows that a beautiful exterior of an ultra slim personal portable device is not damaged and convenient pointing is possible.

### BRIEF DESCRIPTION OF DRAWINGS

FIG. 1 is a diagram illustrating an optical system of a general optical mouse;

FIGS. 2 and 3 are diagrams illustrating the depth of a focus of a condensing lens;

FIG. 4 is a cross-sectional view of an optical pointing device according to a first preferable embodiment of the present invention;

FIG. 5 is a side perspective view of the optical pointing device according to the first preferable embodiment of the present invention;

FIG. 6 is a diagram illustrating the optical path of the optical pointing device according to the first preferable embodiment of the present invention;

FIG. 7 is a cross-sectional view of an optical pointing device according to a second preferable embodiment of the present invention;

FIG. 8 is a side perspective view of the optical pointing device according the second preferable embodiment of the present invention;

FIG. 9 is a diagram illustrating the optical path of the optical pointing device according to the second preferable embodiment of the present invention;

FIG. 10 is a cross-sectional view of the optical pointing device according to an embodiment similar to the second embodiment;

FIG. 11 is a cross-sectional view of an optical pointing device according to a third preferable embodiment of the present invention;

FIG. 12 is a side perspective view of the optical pointing device according to the third preferable embodiment of the present invention;

FIG. 13 is a diagram illustrating the optical path of the optical pointing device according to the third preferable embodiment of the present invention;

FIG. 14 is a cross-sectional view of an optical pointing device according to a fourth preferable embodiment of the present invention;

FIG. 15 is a side perspective view of the optical pointing device according to the fourth preferable embodiment of the present invention;

FIG. 16 is a diagram illustrating the optical path of the optical pointing device according to the fourth preferable embodiment of the present invention;

FIG. 17 is a diagram illustrating the optical path of an optical pointing device according to an embodiment similar to the fourth embodiment;

FIG. 18 is a diagram illustrating an exterior view of a personal portable device employing the optical pointing device according to any one of the first through fourth preferable embodiments of the present invention; and

FIG. 19 is a block configuration diagram of the personal portable device of FIG. 18.

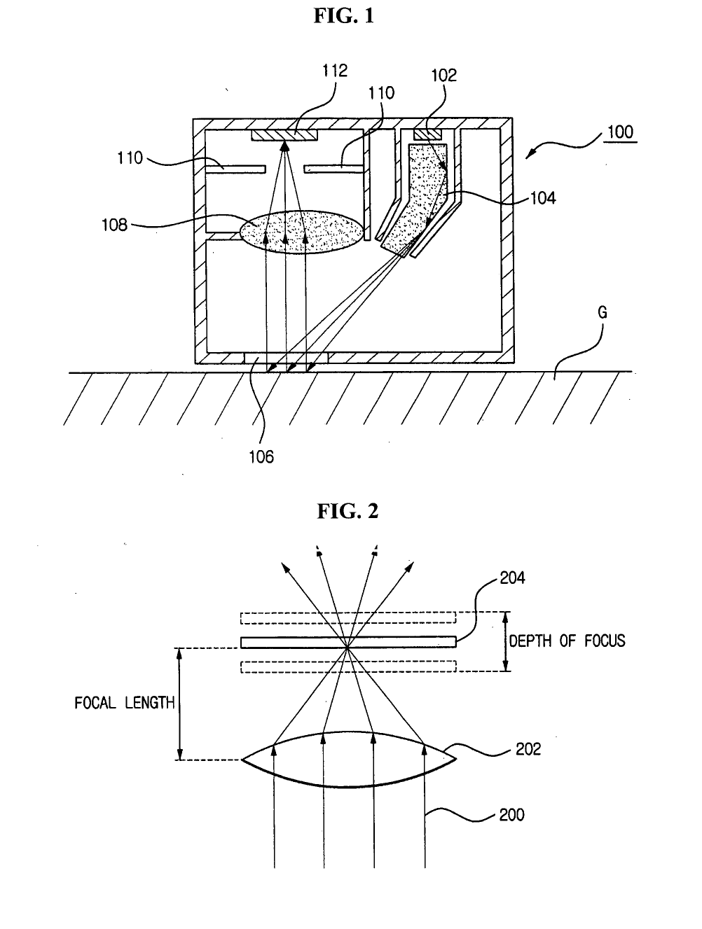

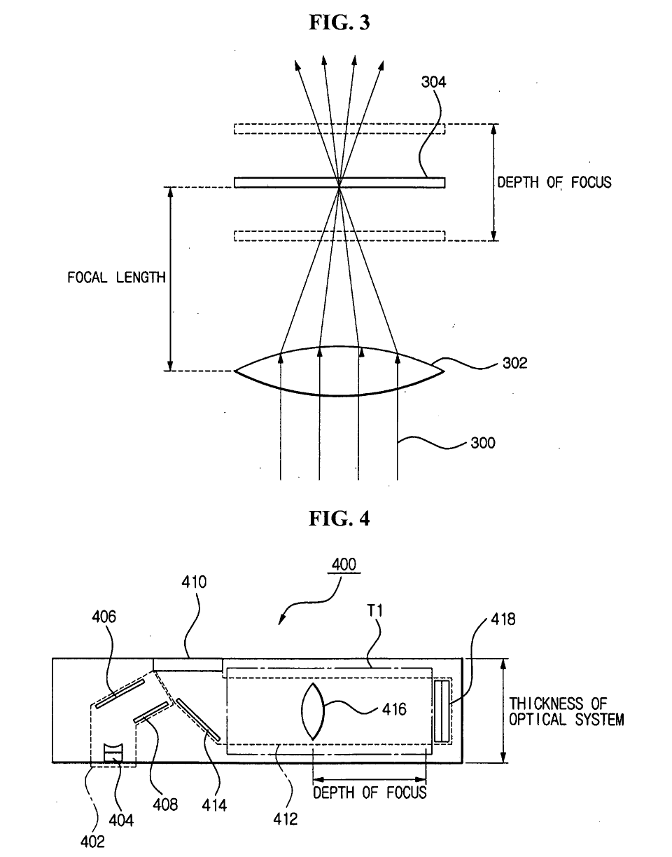

### BEST MODE FOR CARRYING OUT THE INVENTION

Hereinafter, the optical pointing device according to the preferable embodiments of the present invention will be described with reference to the attached drawings.

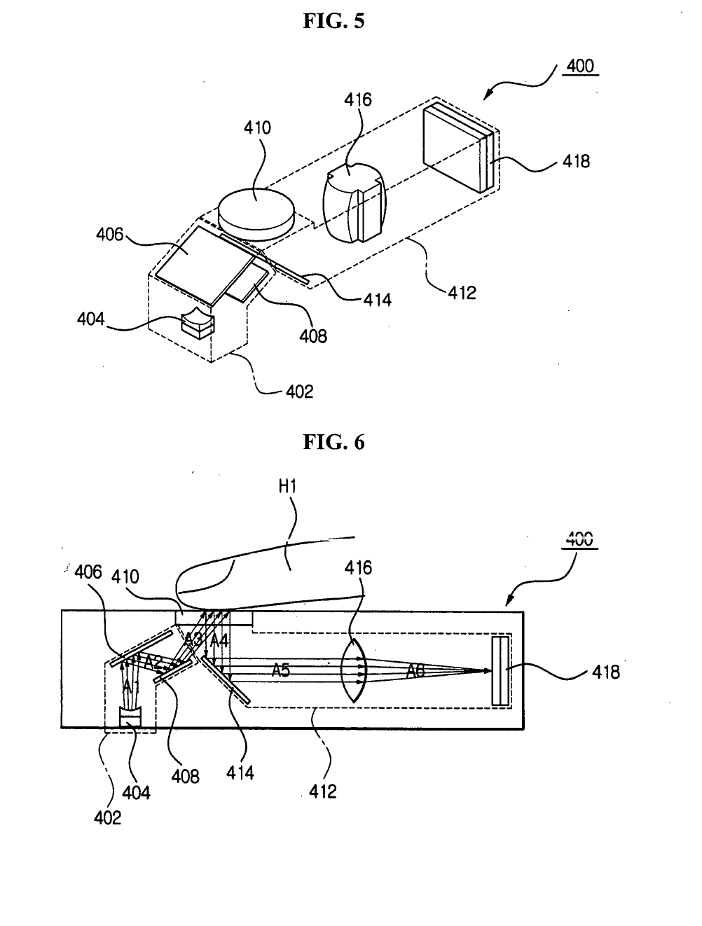

FIG. 4 is a cross-sectional view of an optical pointing device according to a first preferable embodiment of the present invention, FIG. 5 is a perspective view of the optical pointing device according to the first preferable embodiment of the present invention, and FIG. 6 is a diagram illustrating the optical path of the optical pointing device of FIG. 4.

The first preferable embodiment of the present invention is described in detail with reference to FIGS. 4 through 6.

An optical pointing device 400 according to the first preferable embodiment of the present invention includes a light source unit 402, a cover glass 410, and a light-receiving unit 412.

The light source unit 402 of the optical pointing device 400 includes a light source 404, a first guide mirror 406 and a second guide mirrors 408 guiding light emitted from the light source 404. The light source 404 is a surface mounted device (SMD) type light emitting diode (LED) or laser diode, which emits high bright light. The first and second guide mirrors 406 and 408 reflect the light emitted from the light source 404 at a predetermined angle to guide to the cover glass 410. Particularly, first and second guide mirrors 406 and 408 are installed in order to make the light meet the cover glass 410 with forming a small angle, such that the light emitted from the light source 404 enters on the rear surface of the cover glass 410 at a low incidence angle, thereby easily scanning the surface of a finger. The installation position, the number, or the angle of the guide mirrors may be variously modified in order to arrange the light source unit 402 conveniently. Also, the reflecting surfaces of the first and second guide mirrors 406 and 408 are processed by polishing in order to improve the precision of the surface, thereby preventing the loss or diffused reflection of light in reflecting light.

The cover glass 410 of the optical pointing device 400 is a transparent glass which receives light from the light source unit 402 by the rear surface and transmits the light to the top surface. Also, in case that the surface of the finger touches at the top surface of the cover glass 410, the light transmitted through the top surface of the cover glass 410 is reflected by the surface of the finger, the reflected light is received by the top surface and transmitted through the rear surface. The light transmitted through the rear surface is scanned to the light receiving unit 412 of the optical pointing device 400. Also, the top surface and the rear surface of the cover glass 410 is polished in order to improve the precision of the surface, thereby preventing the loss or diffused reflection of light in the incidence or the emission of the light.

The light receiving unit of the optical pointing device 400 includes a first reflecting mirror 414, a condensing lens 416, and an optical image sensor 418. The first reflecting mirror 414 reflects the light reflected by the surface of the finger to guide it to the condensing lens 416. In this case, the light reflected by the first reflecting mirror 414 horizontally travels toward the condensing lens 416 to form a horizontal optical path. Also, a waveguide T1 between the first reflecting mirror 414 and the optical image sensor 418 uses air as a medium, and the condensing lens 416 is inserted into the waveguide T1. The condensing lens 416 is vertically inserted in order to orthogonally face the horizontal optical path, thereby providing convenience of assembling the light receiving unit 412. The condensing lens 416 condenses the light reflected by the first reflecting mirror 414 and transmits the refracted light to the optical image sensor 418. In this case, the reflecting surface of the first reflecting mirror 414 and the lens surface of the condensing lens 416 are polished to improve the precision of a surface, thereby preventing the loss and the diffused reflection of the light in the reflection, incidence, and emission of the light.

The optical image sensor 418 is vertically installed to perpendicularly encounter with the light on the horizontal optical path and the condensed light is prejected on the optical image sensor 418. The optical image sensor 418 provides the pick up information to an image processing unit (not shown) for detecting the movement. The image processing unit detects the direction, speed, and distance of the movement of the surface of the finger via the pick up information and outputs as pointer information.

Since an optical path of the light receiving unit 412 is horizontally formed, not only the thickness of the optical system may be minimized to 2 mm but also an optical path with 15-30 mm for a sufficient depth of a focus may be provided.

The optical path of the optical pointing device 400 according to the first preferable embodiment of the present invention is described with reference to FIG. 6.

Light is emitted from the light source 404 to the first guide mirror 406 (A1), and the first guide mirror 406 reflects the light on the second guide mirror 408 (A2). The light reflected by the second guide mirror 408 is heading straight for the cover glass 410 with a low angle of incidence (A3). The light guided to the cover glass 410 by being reflected by the second guide mirror 408 is transmitted through the cover glass 410 and scanned on the surface of a finger H1. The light is irradiated to the first reflective mirror 414 (A4). The light irradiated to the first reflective mirror 414 is reflected again at a predetermined angle to change the path as horizontal. The horizontal light is irradiated to the condensing lens 416 (A5). The light guided to the condensing lens 416 is condensed and irradiated to the optical image sensor 418 (A6).

In the first preferable embodiment of the present invention, the moving path of the light from the cover glass 410 is converted to be vertical (A5 and A6), thereby providing an optical path of 15-30 mm for a sufficient depth of a focus and slimming the thickness of the light receiving unit 412 to be less than 2 mm.

However, according to the first preferable embodiment of the present invention, since the optical image sensor 418 is vertically installed to be orthogonal to the horizontal optical path, the optical image sensor 418 is difficult to be stably installed at a horizontal printed circuit board (PCB).

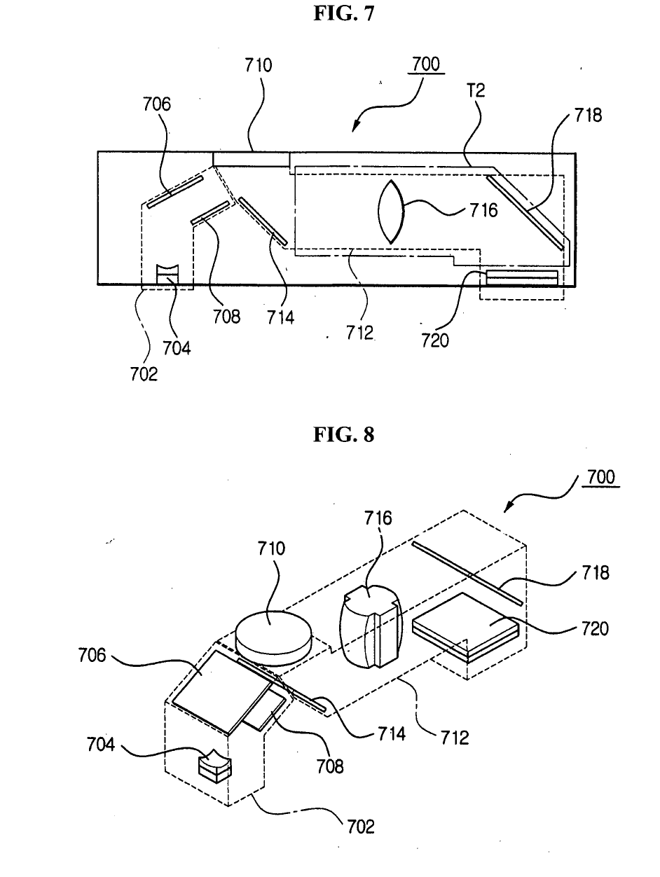

To solve the problem, a second preferable embodiment of the present invention is described in detail with reference to FIGS. 7 through 9.

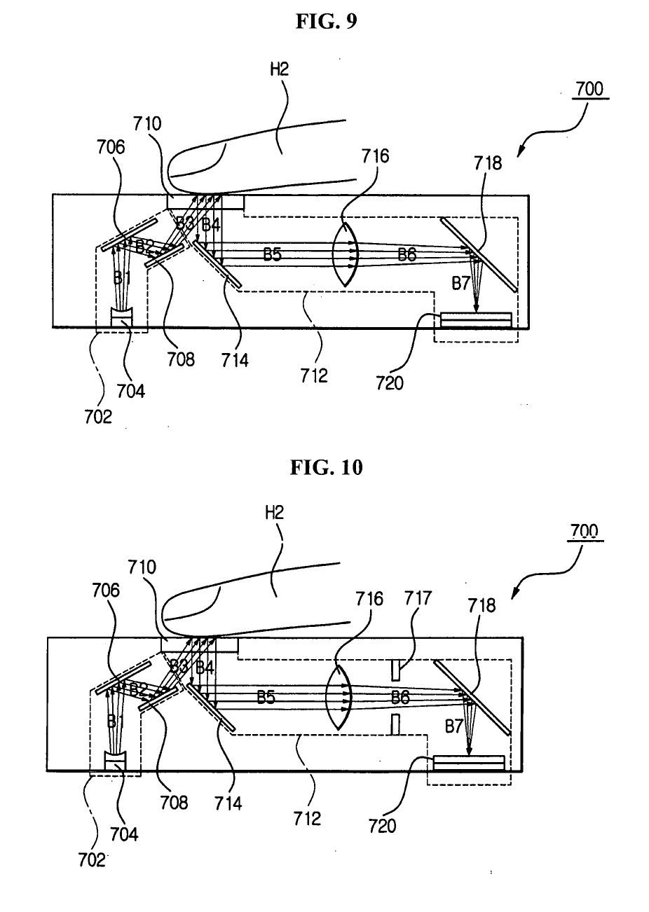

FIG. 7 is a cross-sectional view of an optical pointing device according to a second preferable embodiment of the present invention, FIG. 8 is a side perspective view of the optical pointing device according the second preferable embodiment of the present invention, and FIG. 9 is a diagram illustrating the optical path of the optical pointing device according to the second preferable embodiment of the present invention.

An optical pointing device 700 according to the second preferable embodiment of the present invention includes a light source unit 702, a cover glass 710, and a light receiving unit 712.

The light source unit 702 of the optical pointing device 700 includes a light source 704 and first and second guide reflecting mirrors 706 and 708. The light source 704 is an SMD type LED or a laser diode, which emits high bright light. The first and second guide reflecting mirrors 706 and 708 reflect light emitted from the light source 704 at a predetermined angle to irradiate to the cover glass 710. Particularly, the reflection angle of the first and second guide reflecting mirrors 706 and 708 is determined such that the light is incident on the rear surface of the cover glass 710 at a small angle from the light source 704, thereby easily scanning the surface of a finger. The number or angle of first and second guide reflecting mirrors 706 and 708 are changed in order to change the installation position of the light source 704 or easily arrange the light source unit 702. Also, the reflecting surface of the first and second guide reflecting mirrors 706 and 708 is polished in order to improve the precision of the surface, thereby preventing the loss and the diffused reflection of light, which are possible to be generated in reflecting the light.

The cover glass 710 of the optical pointing device 700 is a transparent glass that receives light from the light source unit 702 by the rear surface and transmits through the top surface. Also, in case that the surface of the finger is closely adhered to the top surface of the cover glass 710, when the light transmitted through the top surface of the cover glass 710 is reflected by the surface of the finger, the reflected light is received by the top surface and transmitted through the rear surface. The light transmitted through the rear surface is provided to the light receiving unit 712 of the optical pointing device 700. Also, the top and rear surfaces of the cover glass 710 are polished to improve the precision of the surface, thereby preventing the loss and the diffused reflection of light, which are possible to be generated in the incidence or refraction of the light.

The light receiving unit 712 of the optical pointing device 700 includes a first reflecting mirror 714, a condensing lens 716, a second reflecting mirror 718, and an optical image sensor 720. The first reflecting mirror 714 reflects the light reflected by the surface of the finger and transmitted through the cover glass 710 at a predetermined angle and irradiates to the light receiving lens 716. In this case, the first reflecting mirror 714 has a reflection angle for forming a horizontal optical path. Also, air is used as a medium between the first reflecting mirror 714 and the second reflecting mirror 718 and in a waveguide T2 between the second reflecting mirror 718 and the optical image sensor 720. The condensing lens 716 is interposed between the first reflecting mirror 714 and the second reflecting mirror 718 in the waveguide T2. The condensing lens 716 is vertically disposed in the horizontal optical path to provide convenience of arranging the light receiving unit 712. The condensing lens 716 condenses the light reflected at the first reflecting mirror 714 and provides to the second reflecting mirror 718. The second reflecting mirror 718 converts the horizontally traveling light into a vertical traveling light and provides to the optical image sensor 720. In this case, the second reflecting mirror 718 reflects the horizontal light at 90° to be vertically irradiated to the image optical image sensor 720 installed at the horizontal PCB. In this case, the reflecting surface of the first and second reflecting mirrors 714 and 718 and the surface of the condensing lens 716 are polished in order to improve the precision of the surface, thereby preventing the loss or diffused reflection of the light, capable of being generated in reflecting the light. The optical image sensor 720 is installed at the horizontal PCB, picks up an image of the light vertically reflected by the second reflecting mirror 718, and provides the pick up information to an image processing unit (not shown) for detecting movement.

In the present embodiment, though one condensing lens 716 is installed between the first and second reflecting mirrors 714 and 718, more than two condensing lenses may be installed. In this case, optical characteristics of the installed condensing lenses, such as the focal length and the sort of lenses, may be identical or differently specified.

The image processing unit detects the direction, speed, and distance of the movement of the surface of the finger via the pick up information and outputs as point information.

Since an optical path for the depth of a focus of the light receiving unit 712 is vertically formed, the thickness of the optical system may not only be minimized but provide a sufficient depth of a focus. Also, the horizontal light is converted into a vertical light and provided to the optical image sensor 720 installed at the horizontal PCB, thereby stably installing the optical image sensor 720.

The optical path of the optical pointing device 700 according to the second preferable embodiment is described with reference to FIG. 9.

Light is emitted from the light source 704 to the first guide mirror 706 (B1), and the first guide mirror 706 reflects the light on the second guide mirror 708 (B2). The light reflected by the second guide mirror 708 goes to the cover glass 710 and meets it forming a small angle (B3). The light guided to the cover glass 710 by being reflected by the second guide mirror 708 is transmitted through the cover glass 710 and scanned on the surface of a finger H1. The light is irradiated to the first reflecting mirror 714 (B4). The light irradiated to the first reflecting mirror 714 is reflected again at a predetermined angle to change the path as horizontal. The horizontal light is irradiated to the condensing lens 716 (B5). The light guided to the condensing lens 716 is condensed and irradiated to the second reflecting mirror (B6). The path of the light irradiated to the second reflecting mirror 718 is changed to be vertical, and the vertical light is irradiated to the optical image sensor 720 (B7).

According to the second preferable embodiment of the present invention, the optical path for the sufficient depth of the focus is horizontally formed (B5 and B6), thereby minimizing the thickness of the optical system and providing a sufficient depth of a focus. Also, the horizontal light is converted into a vertical light (B7), thereby installing the optical image sensor 720 on a horizontal PCB.

Though, it is described for example that only one condensing lens is employed in the first and second preferable embodiments of the present invention, it is apparent that a plurality of the condensing lenses may be included in order to improve condensing efficiency.

Also, as the condensing lens is possible to be formed as a convex lens having 10-90 μm curvature radius by using micro-electro-mechanical system (MEMS), micro injection molding, hot embossing, extra violet hardening molding methods, thereby forming the micro lens as an array structure to reduce the focal length. Particularly, the micro lens is arrayed identical with the number of pixels, thereby clearly picking up an image corresponding to each pixel.

Also, though it is described for example that the waveguides T1 and T2 using air are employed in the first and second preferable embodiments of the present invention, an optical waveguide may be employed to minimize the loss of light.

Also, as shown in FIG. 10, a shading unit 717 may be installed between the condensing lens 716 and the second reflecting mirror 718. The shading unit 717 cuts off noise light except the light passing through the normal path, thereby assisting to form a clear image.

A third preferable embodiment of the present invention employing the optical waveguide is described with reference to FIGS. 11 through 13.

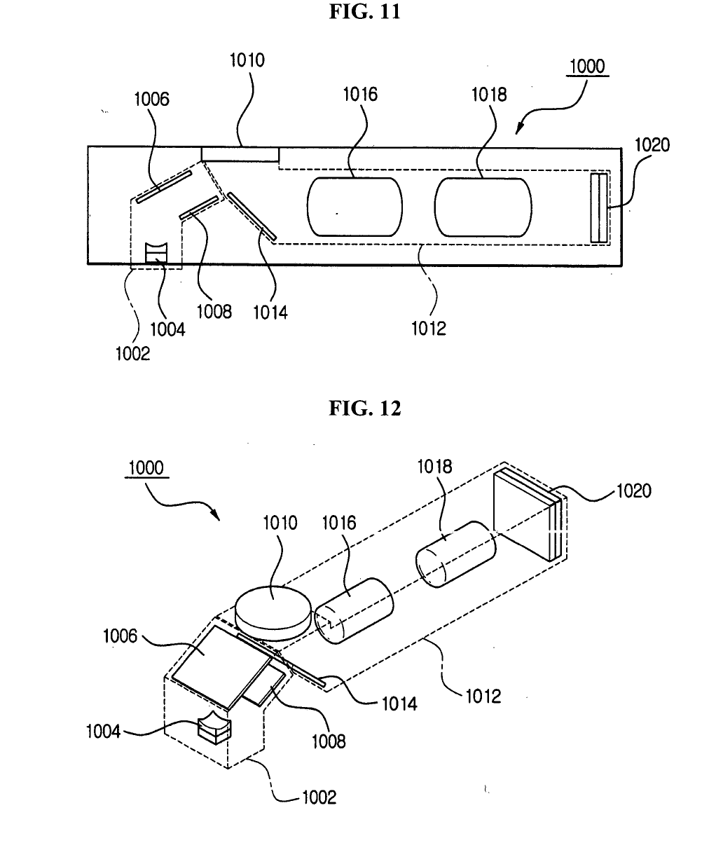

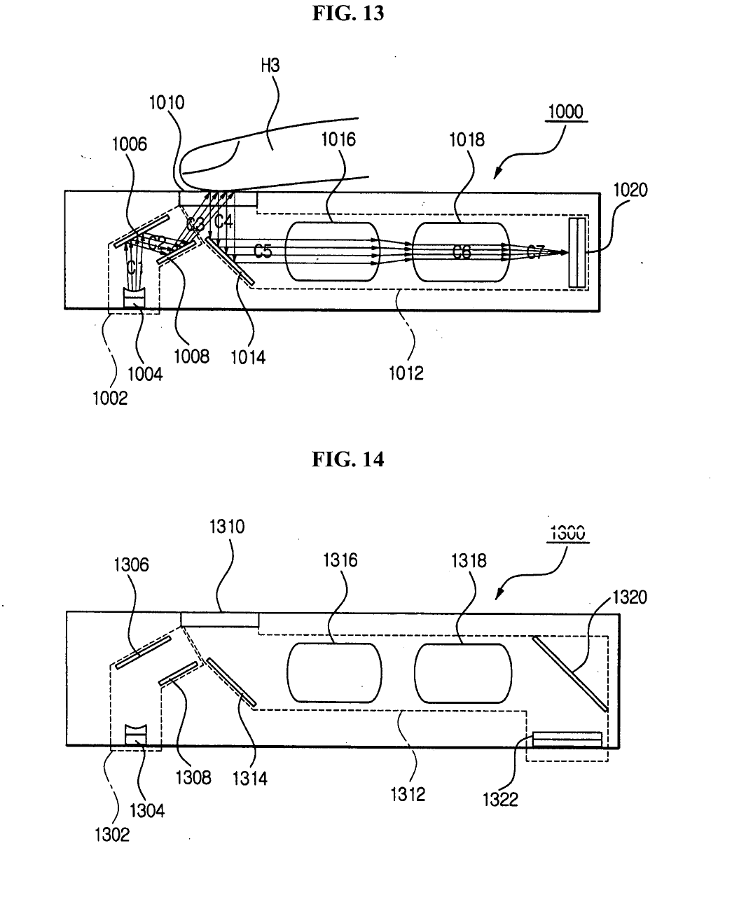

FIG. 11 is a cross-sectional view of an optical pointing device according to a third preferable embodiment of the present invention, FIG. 12 is a side perspective view of the optical pointing device according to the third preferable embodiment of the present invention, and FIG. 13 is a diagram illustrating the optical path of the optical pointing device according to the third preferable embodiment of the present invention.

An optical pointing device 1000 according to the third preferable embodiment of the present invention includes a light source unit 1002, a cover glass 1010, and a light receiving unit 1012.

The light source unit 1002 of the optical pointing device 1000 includes a light source 1004 and first and second guide reflecting mirrors 1006 and 1008. The light source 1004 is an SMD type LED or a laser diode, which emits high bright light. The first and second guide reflecting mirrors reflect light emitted from the light source 1004 at a predetermined angle to irradiate to the cover glass 1010. Particularly, the first and second guide mirrors 1006 and 1008 are installed such that the light emitted from the light source 1004 is incident upon the rear surface of the cover glass 1010 at a small angle. Also, the number or the angle of the first and second guide mirrors 1006 and 1008 may be changed in order to change the installation position of the light source 1004 or easily arrange the light source unit. Also, the reflecting surface of the first and second guide reflecting mirror 1006 and 1008 is polished in order to improve the precision of the surface, thereby preventing the loss and the diffused reflection of light, which are possible to be generated in reflecting the light.

The cover glass 1010 of the optical pointing device 1000 is a transparent glass, which receives light from the light source unit 1002 by the rear surface and transmits to the top surface. Also, in case that the surface of the finger is closely adhered to the top surface of the cover glass 1010, if the light transmitted to the top surface of the cover glass 1010 is reflected by the surface of the finger, the reflected light is received by the top surface and transmitted to the rear surface. The light transmitted to the rear surface is irradiated to the light receiving unit 1012 of the optical pointing device 1000. Also, the top surface and the rear surface of the cover glass 1010 are polished to improve the precision of the surface, there by preventing the loss and diffused reflection of the light, which are possible to be generated in reflecting the light.

The light receiving unit 1012 of the optical pointing device 1000 includes a first reflecting mirror 1014, a first waveguide, and a second waveguide 1018. The first reflecting mirror 1014 reflects light reflected by the surface of the finger and transmitted through the cover glass 1010 at a predetermined angle and provides to the first waveguide 1016. In this case, the first reflecting lens 1014 has a reflection angle for forming a horizontal optical path. The first waveguide 1016 is an optical waveguide composed of a transparent optical plastic or glass, which is horizontally installed on a horizontal optical path and the optical incident surface and the refraction surface are convexly formed, thereby guiding the incident light, firstly condensing, and refracting to the second waveguide 1018. The second waveguide 1018 is an optical waveguide composed of a transparent optical plastic or glass, which is horizontally installed on the horizontal optical path and the optical incident surface and the refraction surface are convexly formed, thereby guiding the incident light, secondly condensing, and refracting to an optical image sensor 1020. The reflecting surface of the first reflecting mirror 1014 and the incident surface and the refraction surface of the first and second waveguides 1016 and 1018 are polished to improve the precision of the surface, thereby preventing the loss and the diffused reflection of the light, which may be generated in reflecting the light. The optical image sensor 1020 is vertically installed on the horizontal optical path, which picks up an image of the light condensed by the first and second waveguides 1016 and 1018 and provides the pick up information to an image processing unit (not shown) for detecting the movement. The image processing unit detects the direction, speed, and distance of the movement of the surface of the finger via the pick up information and outputs as point information.

Since the optical path of the light receiving unit 1012 is horizontally formed, the thickness of the optical system can be minimized to 2 mm and allow to provide an optical path of 15-30 mm for a sufficient depth of a focus. Also, since a plurality of waveguides are installed for optical waveguide on the optical path of the light receiving unit 1012, the loss of the light on the optical path can be minimized.

The optical path of the optical pointing device 1000 according to a third preferable embodiment of the present invention is described with reference to FIG. 13.

Light is emitted from the light source 1004 to the first guide reflecting mirror 1006 (C1), and the first guide reflecting mirror 1006 reflects the light to the second guide reflecting mirror 1008 (C2). The light emitted to the second guide reflecting mirror 1008 is reflected to be irradiated to the cover glass 1010 at a small angle (C3). The light reflected by the second guide reflecting mirror 1008 and irradiated to the cover glass 1010 is transmitted through the cover glass 1010 and irradiated to the surface of a finger H3. The light is reflected at the surface of the finger H3 and irradiated to the first reflecting mirror 1014 (C4). The light irradiated to the first reflecting mirror 1014 is reflected at a predetermined angle and the path is changed as horizontal. The horizontal light is irradiated to the first waveguide 1016 (C5). The light that passes through the first waveguide 1016 and is firstly condensed is irradiated to the second waveguide 1018 (C6). The light that passes through the second waveguide 1018 and is secondly condensed is irradiated to the optical image sensor (C7).

In the third preferable embodiment of the present invention, the optical path is changed to be horizontal from the cover glass 1010, thereby providing the 15-30 mm optical path for a sufficient depth of a focus and reducing the thickness of the light receiving unit 412 to 2 mm. Also, the first and second waveguides 1016 and 1018 are provided on the optical path, thereby minimizing the loss of the light on the optical path.

However, there is a problem that the optical image sensor 1020 is difficult to be stably installed on the horizontal PCB because the optical image sensor 1020 is vertically installed on the horizontal optical path.

A fourth preferable embodiment of the present invention for solving the problem is described in detail with reference to FIGS. 14 through 16.

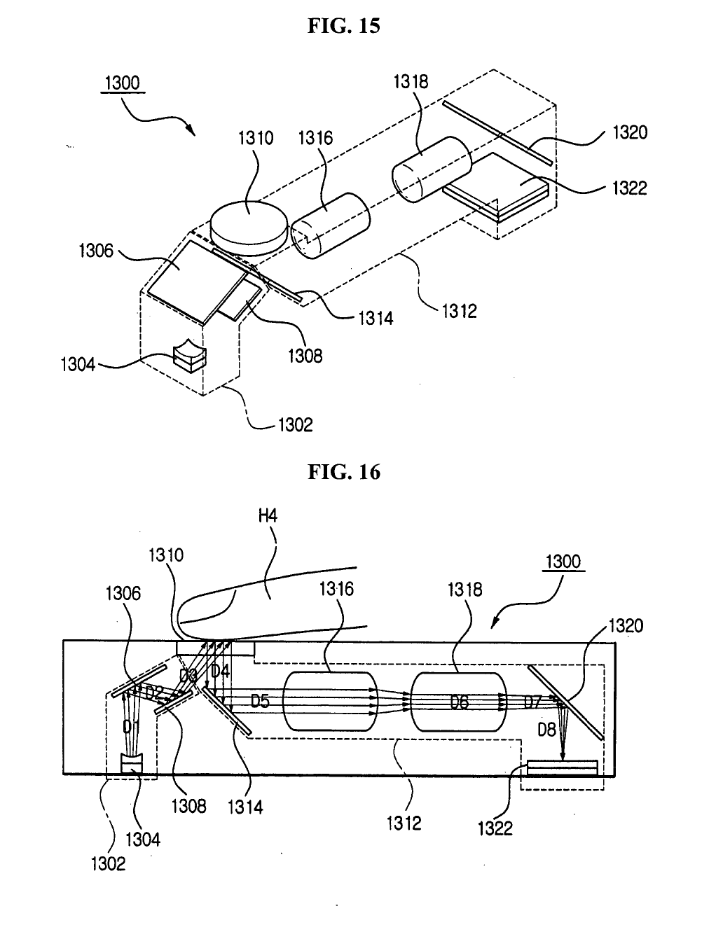

FIG. 14 is a cross-sectional view of an optical pointing device according to a fourth preferable embodiment of the present invention, FIG. 15 is a side perspective view of the optical pointing device according to the fourth preferable embodiment of the present invention, and FIG. 16 is a diagram illustrating the optical path of the optical pointing device according to the fourth preferable embodiment of the present invention.

An optical pointing device 1300 according to the fourth preferable embodiment of the present invention includes a light source unit 1302, a cover glass 1310, and a light receiving unit 1312.

The light source unit 1302 of the optical pointing device 1300 includes a light source 1304 and first and second guide reflecting mirrors 1306 and 1308. The light source is an SMD type LED or a laser diode, which emits high bright light. The first and second guide reflecting mirrors 1306 and 1308 reflect light emitted from the light source 1304 at a predetermined angle and irradiate to the cover glass 1310. Particularly, the reflection angle of the first and second guide reflecting mirrors 1306 and 1308 is determined such that the light emitted from the light source is incident to the rear surface of the cover glass 1310 at a small angle for easily scanning the surface of a finger. The number or the angle of the first and second guide reflecting mirrors 1306 and 1308 may be changed in order change the installation position or easily arrange the light source unit 1302. Also, the reflecting surface of the first and second guide reflecting mirrors 1306 and 1308 is polished to improve the precision of the surface, thereby preventing the loss and the diffused reflection of the light, which may be generated in reflecting the light.

The cover glass 1310 of the optical pointing device 1300 is a transparent glass receiving the light from the light source unit 1302 by the rear surface and transmitting to the top surface. Also, in case that the surface of a finger is closely adhered to the top surface of the cover glass 1310, if the light transmitted to the top surface of the cover glass 1310 is reflected by the surface of the finger, the reflected light is received by the top surface and transmitted through the rear surface. Also, the top surface and the rear surface of the cover glass 1310 are polished in order to improve the precision of the surface, thereby preventing the loss and the diffused reflection of the light, which may be generated in reflecting the light.

The light receiving unit of the optical pointing device 1300 includes a first reflecting mirror 1314, first and second waveguides 1316 and 1318, a second reflecting mirror 1320, and an optical image sensor 1322. The first reflecting mirror 1314 reflects the light reflected by the surface of the finger and transmitted through the cover glass 1310 at a predetermined angle and irradiates to the first waveguide 1316. In this case, the first reflecting mirror 1314 has a reflection angle for forming a horizontal optical path. The first waveguide 1314 is an optical waveguide composed of a transparent optical plastic or glass, whose incident surface and the refraction surface are convexly formed, horizontally installed on a horizontal optical path. The first waveguide 1314 guides and firstly condenses the incident light to refract to the second waveguide 1318. The second waveguide 1318 is horizontally installed on the horizontal optical path, whose incident surface and the refraction surfaces are convexly formed. The second waveguide 1318 guides and secondly condenses the incident light to refract to the second reflecting mirror 1320. The second reflecting mirror 1320 converts the light refracted by the second reflecting mirror 1320 into a vertical light and irradiates to the optical image sensor 1322. In this case, the second reflecting mirror 1320 reflects the horizontal light at 90° such that the horizontal light can be vertically irradiated to the optical image sensor 1322 installed on the horizontal PCB. Also, the reflecting surface of the first and second reflecting mirrors 1314 and 1320 and the incident surface and the refraction surface of the first and second waveguides 1316 and 1318 are polished to improve the precision of the surface, thereby preventing the loss and the diffused reflection of the light, which may be generated in reflecting the light. The optical image sensor 1322 is installed on the horizontal PCB, picks up an image of the light vertically reflected by the second reflecting mirror 1320, and provides pick up information to an image processing unit (not shown) for detecting the movement. The image processing unit detects the direction, speed, and distance of the movement of the surface of the finger via the pick up information and outputs as pointer information.

The optical path for the depth of a focus of the light receiving unit 1312 is horizontally formed and a plurality of waveguides are installed, thereby minimizing the thickness of an optical system, providing a sufficient depth of a focus, and minimizing the loss of the light on the optical path. Also, the horizontal light is converted into a vertical light and provided to the optical image sensor 1322 installed on the horizontal PCB, thereby stably installing the optical image sensor 1322.

The optical path of the optical pointing device 1300 according to the fourth preferable embodiment of the present invention is described with reference to FIG. 16.

Light is emitted from the light source 1304 to the first guide reflecting mirror 1306 (D1). The first guide reflecting mirror 1306 reflects the light to the second guide reflecting mirror 1308 (D2). The light irradiated to the second guide reflecting mirror 1308 is reflected to be irradiated to the cover glass 1310 at a small angle (D3). The light reflected by the second guide reflecting mirror 1308 and irradiated to the cover glass 1310 is transmitted through the cover glass 1310 and irradiated to the surface of a finger H4. The light is reflected by the surface of the finger H4 and irradiated to the first reflecting mirror 1314 (D4). The light irradiated to the first reflecting mirror 1314 is reflected again at a predetermined angle such that the path is changed to be horizontal, and the horizontal light is irradiated to the first waveguide 1316 (D5). The light passing through the first waveguide 1316 and secondly condensed is irradiated to the second reflecting mirror 1320 (D7). The light secondly condensed and irradiated to the second reflecting mirror 1320 is reflected at a predetermined angle such that the path is changed to be vertical, and the vertical light is irradiated to the optical image sensor 1322 installed on the horizontal PCB (D8).

According to the fourth preferable embodiment of the present invention, a plurality of waveguides are horizontally installed on the path of the light from the cover glass 1310 (D5, D6, and D7), thereby providing a 15-30 mm optical path for a sufficient depth of a focus, reducing the thickness of the light receiving unit 1312 to less than 2 mm, and minimizing the loss of the light on the optical path. Also, the horizontal light is converted into a vertical light (D8), thereby stably installing the optical image sensor 1322 on the horizontal PCB.

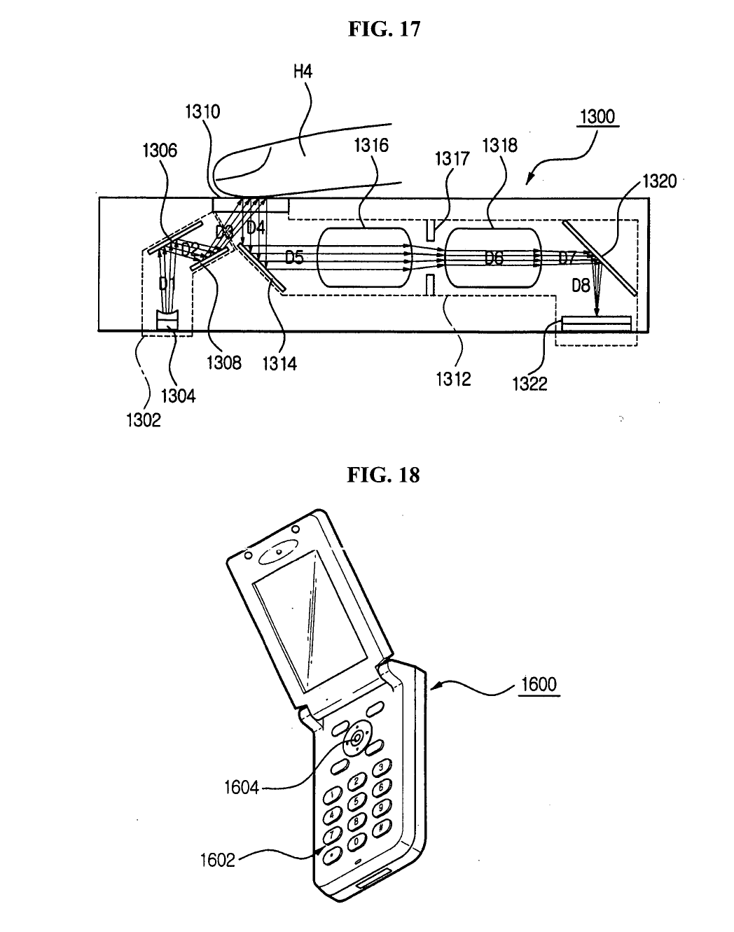

Also, as shown in FIG. 17, a shading unit 1317 may be installed between the first waveguide 1316 and the second waveguide 1318. The shading unit cuts off noise light except the light passing through a normal path, thereby assisting to form a sharp image. In FIG. 17, though the shading unit 1317 is interposed between the first waveguide 1316 and the second waveguide 1318, the shading unit may be additionally installed between the second waveguide 1318 and the second reflecting mirror 1320.

The optical pointing device according to any one of the first through fourth preferable embodiments of the present invention may be installed in a personal portable device.

Hereinafter, a personal portable device equipped with the optical pointing device according to the any one of the first through fourth preferable embodiments of the present invention is described.

Referring to FIG. 18 illustrating an exterior view of a mobile phone equipped with the optical pointing device, the optical pointing device according to any one of the first through fourth preferable embodiments of the present invention may be installed at a predetermined part of the mobile phone 1600, and a cover glass 1604 according to any one of the first through fourth embodiments may be installed at a predetermined part of a keypad 1602 of the mobile phone 1600, thereby a user may point by moving the surface of a finger as an object.

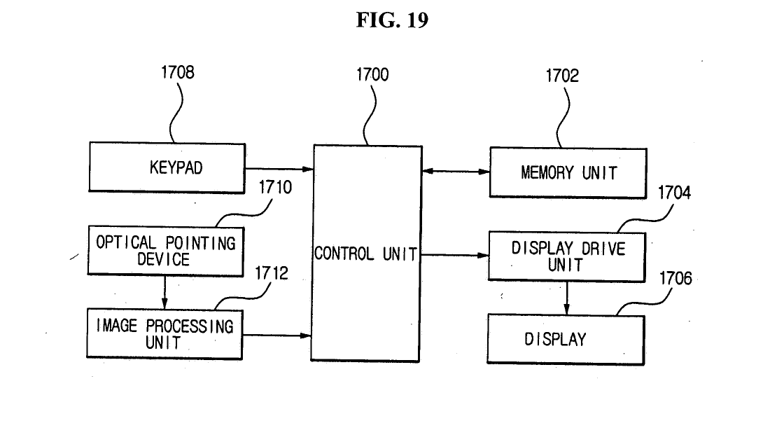

The configuration of the mobile phone is described with reference to FIG. 19.

A control unit 1700 of the mobile phone controls not only the overall mobile phone but also a display drive unit 1704 such that information on the speed, direction, and distance of the movement of the finger that is an object is received from an image processing unit 1712 and a pointer shown in a display 1706 is changed according to the information. Also, the control unit 1700 performs the operations according to operating click buttons included in the keypad 1708. The memory unit 1702 stores various pieces of information, including a processing program of the control unit 1700. The display drive unit 1704 displays a screen on the display 1706 according to the control of the control unit 1700 and changes the position of the pointer shown on the screen. The keypad 1708 includes a plurality of keys to provide a signal according to inputting the key to the control unit 1700 and further includes the click button used in pointing according to the present invention. An optical pointing device 1710 picks up an image of the finger that is the object and provides to the image processing unit 1712. The image processing unit 1712 generates pointer information on the speed, direction, and distance of the movement of the finger by using the pick up information and provides to the control unit 1700.

As described above, the mobile phone performs pointing according to the speed, direction, and distance of the movement of the finger.

### INDUSTRIAL APPLICABILITY

According to the present invention, pointing is possible by using the surface of a finger and a horizontal optical path is formed such that the thickness of an optical system is minimized, and a sufficient depth of a focus is provided, thereby keeping a beautiful exterior of an ultra slim personal portable device and performing convenient pointing.

Also, according to the present invention, the loss of the light on the optical path can be minimized.

Also, though a horizontal optical path is formed, an optical image sensor can be stably installed on a horizontal PCB.

As described above, although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

Therefore, the scope of the invention is defined not by the detailed description of the invention but by the appended claims, and all differences within the scope will be construed as being included in the present invention.

1. An optical pointing device capable of being installed at a slim personal portable device, comprising:
a cover glass closely contacting an object;
a light source unit emitting light to the cover glass; and
a light receiving unit reflecting the light reflected by the object in a predetermined direction and condensing the light, and picking up an image of the light.

2. The device of claim 1, wherein the light source unit comprises a light source emitting light and a light source guide guiding the light emitted from the light source to the cover glass.

3. The device of claim 1, wherein the light receiving unit comprises:
a reflecting mirror for reflecting the light reflected by the object at the cover glass, the reflected light traveling horizontally;
at least one condensing lens disposed on the path of the light reflected by the reflecting mirror to condense the light; and
an optical image sensor picking up the image of the light transmitted through the condensing lens.

4. The device of claim 1, wherein the light receiving unit comprises:
a first reflecting mirror for reflecting the light reflected by the object at the cover glass, the light traveling horizontally;
at least one condensing lens disposed on the path of the light reflected by the reflecting mirror to condense the light;
a second reflecting mirror for reflecting the condensed light transmitted through the condensing lens downward; and
an optical image sensor picking up the image of the light reflected by the second reflecting mirror.

5. The device of claim 1, wherein the light receiving unit comprises:
a reflecting mirror for reflecting the reflected light in a predetermined direction;
at least one wave guide installed in the predetermined direction to the reflecting mirror, to guide and condense the light; and
an optical image sensor installed next to the wave guide to pick up the image of the condensed light.

6. The device of claim 1, wherein the light receiving unit comprises:
a first reflecting mirror for reflecting the reflected light in a first direction;
at least one wave guide installed in the first direction to the first reflecting mirror, to guide and condense the light;
a second reflecting mirror for reflecting the condensed light to a second direction; and
an optical image sensor installed in the second direction to the second reflecting mirror, to pick up the image of the condensed light.

7. The device of claim 5, wherein the wave guide has an incidence face and a refraction face, which are plano-convex.

8. The device of claim 1, wherein the optical path in the predetermined direction is longer than a length for providing a sufficient depth of a focus.

9. The device of claim 1, wherein the light receiving unit includes a shading unit installed on the path of the light to remove noise of the light.

10. A personal portable device equipped with an optical pointing device, comprising:
an optical pointing device including:
a cover glass closely contacting an object;
a light source unit emitting light to the cover glass; and
a light receiving unit reflecting the light reflected by the object in a predetermined direction, condensing the light, and picking up an image of the condensed light;
a display displaying a view for showing various information and a pointer;
a display drive unit driving the display;
an image processing unit detecting the speed, direction, and distance of the movement of the object based on information on the image picked up by the optical pointing device; and
a control unit controlling the display drive unit to change the position of the pointer according to the speed, direction, and distance of the movement of the object.

11. The device of claim 10, further comprising a keypad including click buttons, wherein the control unit performs the operation according to the handling of the click buttons.

12. The device of claim 6, wherein the wave guide has an incidence face and a refraction face, which are plano-convex.
